(19) United States
(12) Patent Application Publication
(10) Pub. No.: US 2017/0086061 A1
(43) Pub. Date: Mar. 23, 2017

(54) DYNAMIC ASSIGNMENT OF STATIONS TO MULTI-USER GROUP IDENTIFIERS

(71) Applicant: QUALCOMM Incorporated, San Diego, CA (US)

(72) Inventors: Xiaolong Huang, Morgan Hill, CA (US); Chao Zou, San Jose, CA (US); Srinivas Katar, Fremont, CA (US)

(21) Appl. No.: 14/861,992

(22) Filed: Sep. 22, 2015

(51) Int. Cl. H04W 8/18; H04L 12/851; H04W 28/08

(52) U.S. Cl. CPC H04W 8/186; H04W 28/08; H04L 47/24

(57) ABSTRACT

Methods, systems, and devices are described for wireless communication. An access point (AP) may group stations (STAs) into multi-user (MU) groups with group identifiers (IDs). Within each MU group, the AP may dynamically configure several STAs into a transmission set. Each transmission set may include a different combination of STAs. In some cases, the AP may assign a STA to multiple transmission sets within a group ID. In certain scenarios, the AP may assign a STA to more than one group ID. The AP may restrict the number of group IDs to which a STA is assigned. Each MU group may include a number of user positions that may be occupied by one or more STAs. In some cases, the AP may restrict the number of STAs that may be assigned to (i.e., occupy) each user position.

### BACKGROUND

The following relates generally to wireless communication, for example to dynamic assignment of stations to multi-user group identifiers (IDs).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), may include an access point (AP) that may communicate with one or more stations (STAs) or mobile devices. The AP may be coupled to a network, such as the Internet, and may enable a mobile device to communicate via the network (or communicate with other devices coupled to the access point in service set, e.g., a basic service set (BSS) or extended service set (ESS)). A wireless device may communicate with a network device bi-directionally. For example, in a WLAN, a STA may communicate with an associated AP via downlink (DL) and uplink (UL). From the perspective of the STA, the DL (or forward link) may refer to the communication link from the AP to the STA, and the UL (or reverse link) may refer to the communication link from the STA to the AP.

In some cases, an AP may communicate with more than one STA simultaneously in a multi-user (MU) transmission. The AP may send an MU transmission to a group of STAs (i.e., a transmission set) that are assigned the same group ID and that each have data ready for transmission. However, not all STAs in a transmission set may have available data ready to send. When such a scenarios occurs, the AP may wait until each STA in the MU transmission set has queued data before sending the MU transmission. Such a delay in MU transmissions may decrease system efficiency and throughput.

### SUMMARY

Systems, methods, and apparatuses for dynamic assignment of stations to multi-user group IDS are described. In a wireless communication system, an access point (AP) may group stations (STAs) into multi-user (MU) groups for multi-user transmissions. The AP may assign the STAs of an MU group a group identifier (ID). Within each MU group, the AP may dynamically configure several STAs into a transmission set. Each transmission set may include a different combination of STAs. In some cases, the AP may assign transmission sets such that a STA may have multiple partner STAS (i.e., a STA may be in more than one transmission set). In certain scenarios, the AP may assign a STA to more than one group ID; thus, the STA may have different partners per group ID. However, the AP may restrict the number of group IDs to which a STA is assigned. Each MU group may include a number of user positions that may be occupied by one or more STAs. In some cases, the AP may restrict the number of STAs that may be assigned to (i.e., occupy) each user position. The maximum number of STAs that may be assigned to a user position may be based at least in part on the reuse factor of the group ID which indicates the number of STAs that may be include in a transmission set. In some cases, the AP may assign STAs to group IDs or transmission sets based at least in part on queued traffic for the STAs. An AP may determine restrictions on group assignments based at least in part on energy consumption or management overhead.

A method of wireless communication at a wireless device is described. The method may include identifying by an AP a plurality of stations, wherein each station of the plurality of stations supports multi-user transmissions, determining a group identifier (ID) threshold for a station in the plurality of stations, the group ID threshold indicating a maximum number of group IDs permitted to be assigned to the station, and assigning the station to a group ID based at least in part on the group ID threshold associated with the station.

A communication device for wireless communication is described. The communication device may include a station identifier to identify a plurality of stations, wherein each station of the plurality of stations supports multi-user transmissions, a group ID threshold coordinator to determine a group identifier (ID) threshold for a station in the plurality of stations, the group ID threshold indicating a maximum number of group IDs permitted to be assigned to the station, and a station assignment administrator to assign the station to a group ID based at least in part on the group ID threshold associated with the station.

A further communication device for wireless communication is described. The communication device may include means for identifying a plurality of stations, wherein each station of the plurality of stations supports multi-user transmissions, means for determining a group identifier (ID) threshold for a station in the plurality of stations, the group ID threshold indicating a maximum number of group IDs permitted to be assigned to the station, and means for assigning the station to a group ID based at least in part on the group ID threshold associated with the station.

A non-transitory computer-readable medium storing code for wireless communication at a wireless device is described. The code may include instructions executable to identify a plurality of stations, wherein each station of the plurality of stations supports multi-user transmissions, determine a group identifier (ID) threshold for a station in the plurality of stations, the group ID threshold indicating a maximum number of group IDs permitted to be assigned to the station, and assign the station to a group ID based at least in part on the group ID threshold associated with the station.

In some examples of the method, communication devices, or non-transitory computer-readable medium described above, assigning the station to the group ID includes determining a number of group IDs to which the station is assigned, and, if the number of group IDs is less than the group ID threshold, assigning the station to the group ID. In some examples, assigning the station to the group ID further includes determining that the station has data ready for transmission.

Some examples of the method, communication devices, or non-transitory computer-readable medium described above may further include monitoring a data transmission queue associated with each of the stations assigned to the group ID to determine whether that station has data ready for transmission. Additionally or alternatively, some examples may include determining another group ID is assigned to the station, wherein a group of stations associated with the other group ID has insufficient data for a multi-user transmission, and disassociating the station from the group ID.

In some examples of the method, communication devices, or non-transitory computer-readable medium described above, assigning the station to the group ID is further based at least in part on a modulation and coding scheme (MCS) of the station such that a group of stations from the plurality of stations associated with the group ID have the same MCS. In some examples, assigning the station to the group ID is further based at least in part on a traffic priority of the station.

Some examples of the method, communication devices, or non-transitory computer-readable medium described above may further include identifying a plurality of positions for the group ID. In some cases, assigning the station to the group ID further includes assigning the station to an available position of the plurality of positions based at least in part on a reuse threshold applicable to the available position. In some examples, assigning the station to the group ID is based at least in part on a grouping diversity of the group ID to which the station is assigned. In some examples, assigning comprises randomly assigning. Additionally or alternatively, some examples may include assigning sequentially a plurality of new stations to the plurality of positions, wherein the plurality of new stations are associated with a set of group ID thresholds, and wherein a set of reuse thresholds are applicable to the plurality of positions. In some cases, a unique combination of stations is assigned to each position of the plurality of positions.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) for dynamic assignment of stations to multi-user group identifiers (IDs) configured in accordance with various aspects of the present disclosure;

FIG. 2 illustrates an example of a wireless communications subsystem that supports dynamic assignment of stations to multi-user group IDs in accordance with various aspects of the present disclosure;

FIG. 3 illustrates an example of multi-user (MU) transmission sets that support dynamic assignment of stations to multi-user group IDs in accordance with various aspects of the present disclosure;

FIG. 4 illustrates an example of group IDs that support dynamic assignment of stations to multi-user group IDs in accordance with various aspects of the present disclosure;

FIG. 5 illustrates an example of a flow chart for dynamic assignment of stations to multi-user group IDs in accordance with various aspects of the present disclosure;

FIG. 6 illustrates an example of a flow chart for dynamic assignment of stations to multi-user group IDs in accordance with various aspects of the present disclosure;

FIG. 7A illustrates an example of a flow chart for dynamic assignment of stations to multi-user group IDs in accordance with various aspects of the present disclosure;

FIG. 7B illustrates an example of a flow chart for dynamic assignment of stations to multi-user group IDs in accordance with various aspects of the present disclosure;

FIG. 8 shows a block diagram of a wireless device that supports dynamic assignment of stations to multi-user group IDs in accordance with various aspects of the present disclosure;

FIG. 9 shows a block diagram of a wireless device that supports dynamic assignment of stations to multi-user group IDs in accordance with various aspects of the present disclosure;

FIG. 10 illustrates a block diagram of a system including an AP that supports dynamic assignment of stations to multi-user group IDs in accordance with various aspects of the present disclosure;

FIG. 11 illustrates a block diagram of a system including an AP that supports dynamic assignment of stations to multi-user group IDs in accordance with various aspects of the present disclosure;

FIG. 12 illustrates a method for dynamic assignment of stations to multi-user group IDs in accordance with various aspects of the present disclosure; and

FIG. 13 illustrates a method for dynamic assignment of stations to multi-user group IDs in accordance with various aspects of the present disclosure.

### DETAILED DESCRIPTION

An access point (AP) may group stations (STAs) capable of supporting multi-user (MU) transmissions into MU groups. Each STA in an MU group may be assigned a common group identifier (ID) which distinguishes the MU group from other MU groups. An AP may send an MU transmission to a transmission set of STAs within an MU group. The transmission set may be a unique combination of STAs with the same group ID. The AP may dynamically configure transmission sets for an MU group. The AP may partner a STA with different sets of STAs within the MU group; that is, a STA may be paired with various combinations of STAs. The AP may configure or update transmission sets based at least in part on the data available for the STAs in an MU group. In some cases, a STA may be assigned to more than one MU group; that is, the STA may be assigned group ID. Thus, within each MU group a STA may be part of different transmission sets. In some cases, the AP may restrict the number of group IDs to which a STA may be assigned. The AP may restrict the number of STAs that may be assigned to a group ID. For example, the AP may restrict the number of STAs that may occupy a user position within an MU group. The AP may determine such restrictions based at least in part on energy consumption of the STAS or management overhead. These and other aspects of the disclosure are further illustrated by and described with reference to apparatus diagrams, system diagrams, and flowcharts that relate to dynamic assignment of stations to multi-user group IDs.

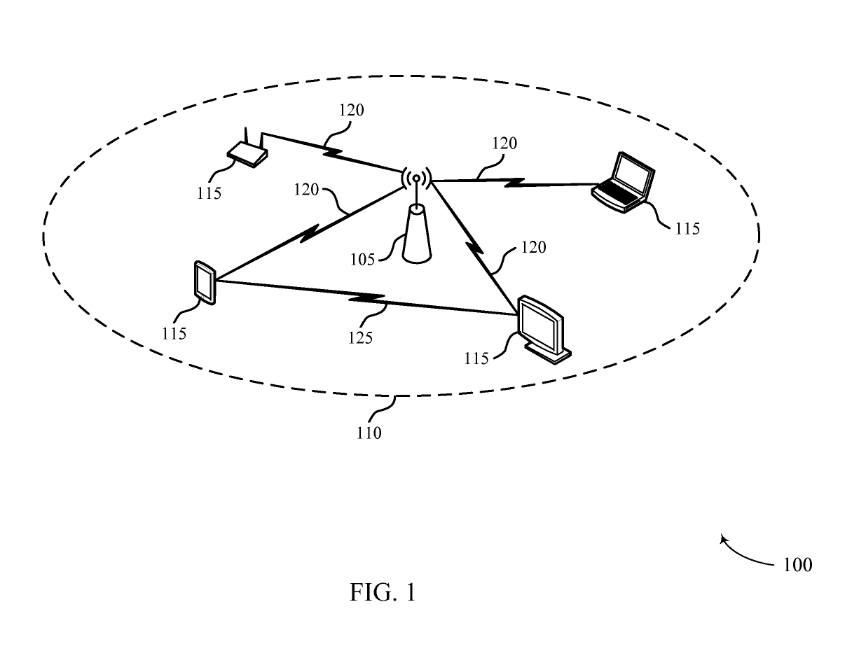

FIG. 1 illustrates a wireless local area network (WLAN) 100 configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (DS) (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11 ac, 802.11 ad, 802.11 ah, etc. In other implementations, peer-to-peer connections or ad hoc networks may be implemented within WLAN 100.

WLAN 100 may increase throughput and reliability by supporting certain transmission techniques such as multiple-input-multiple-output (MIMO) and multi-user MIMO (MU-MIMO). A MIMO communication may involve multiple transmitter antennas (e.g., at an AP 105) sending a signal to multiple receive antennas (e.g., at a STA 115). Each transmitting antenna may transmit independent data (or spatial) streams which may increase diversity (e.g., spatial diversity) and the likelihood successful signal reception. In other words, MIMO techniques use multiple antennas on an AP 105 or multiple antennas on a STA 115 to take advantage of multipath environments to transmit multiple data streams. In some cases, an AP 105 may implement MU-MIMO transmissions in which the AP 105 simultaneously transmits independent data streams to multiple STAs 115. For example, in an MU-N transmission, an AP 105 may simultaneously transmit signals to N STAs. Thus, when an AP 105 has traffic for many STAs 115, the AP 105 may increase network throughput by aggregating individual streams for each STA 115 into a single MU-MIMO transmission.

An AP 105 may implement an identification scheme in order to distinguish the STAs 115 that are the target recipients of an MU transmission. For example, an AP 105 may assign a number of STAs 115 to a group identifier (ID). The stations and group ID may be called an MU group. The AP 105 may furthermore assign a number of the STAs 115 in the MU group to transmissions sets. Each transmission set may be a different combination of STAs 115. Thus, a group ID may be reused for different transmission sets within an MU group. When each STA 115 in a transmission set has data ready for transmission at the AP 105, the AP 105 may send an MU transmission to the STAs 115 of the transmission set. The MU transmission may include the group ID associated with the transmission set for which the MU transmission is intended. Thus, each STA 115 assigned the group ID may wake up to process the MU transmission. The MU transmission may additionally include a field indicating which spatial streams, if any, a STA 115 should demodulate (e.g., a number of space time streams (NSTS) field). Thus, the STAs 115 within the target transmission set may receive the data conveyed by the MU transmission.

In some cases, the transmission set for a group ID is statically assigned. That is, the STAs 115 of an MU group may grouped according to a fixed MU grouping, where every STA 115 is grouped with a fixed set of partner STAs 115 for MU transmissions. However, an AP 105 may wait until each STA 115 in a transmission set has data ready for transmission (e.g., packets queued in a firmware buffer) before sending an MU transmission to the transmission set. In such cases, waiting for available data may reduce the density of MU transmissions. Thus, an AP 105 may employ dynamic transmissions sets. In a dynamic transmission set implementation, an AP 105 may dynamically assign STAs 115 to transmission sets based at least in part on traffic for each of the STAs 115.

Each MU group may include a number of user positions. The number of user positions may be defined by the reuse factor for the group ID which indicates the number of STAs 115 supported by an MU transmission. For example, a reuse factor of N indicates that N STAs 115 may receive data conveyed by an MU transmission. Thus, a group ID assigned a reuse factor of 3 may include 3 positions. Each position may be occupied by more than one STA 115. For example, each position may be occupied by Nᵣₑᵤₛₑ of STAs 115, where Nᵣₑᵤₛₑ is the group ID reuse factor and indicates the number of STAs per position and is less than or equal to Nᵣₑᵤₛₑ_{_}ₘₐₓ. That is, Nᵣₑᵤₛₑ may define the maximum number of STAs 115 permitted to occupy a position in an MU group. Nᵣₑᵤₛₑ_{_}ₘₐₓ may be statically or dynamically determined, and may be different for different positions within an MU group. In some cases, Nᵣₑᵤₛₑ_{_}ₘₐₓ is equal to the reuse factor for the group ID.

An MU transmission assigned a group ID may be convey data intended for a transmission set within that group ID. The transmission set may include a STA 115 from each position in the MU group. That is, for an MU group with a reuse factor of 3, a transmission set may include a STA 115 from position 1, a STA 115 from position 2, and a STA 115 from position 3. An MU group may be assigned fixed transmission sets; that is, each transmission set may be statically assigned a combination of STAs 115 that does not change. For example, a STA 115 A may be constantly partnered with a STA 115 B and a STA 115 C. In some cases, an MU group includes dynamic transmission sets; that is, the MU group may have transmissions sets that are adaptively configured to include various combinations of STAs 115. For example, a STA 115 A may be partnered with a STA 115 B and a STA 115 C in a first MU transmission, and partnered with a STA 115 D and a STA 115 E in a subsequent MU transmission.

In some cases, a STA 115 is assigned more than one group ID. Each group ID may include a different combination of STAs 115. In other words, a STA 115 may be partnered with different STAs 115 per group ID. The number of STAs 115 (or user positions) per group ID may be defined by the reuse factor. For example, a group ID with a reuse factor of 3 may indicate that an MU transmission for the group ID may include data for 3 STAs 115. The number of group IDs to which a STA 115 is assigned may be referred to as N_{groups}_{_}ₚₑᵣ_{_}_{STA}. In some cases, there may be a threshold (e.g., maximum) number of group IDs to which a STA 115 is assigned. That is, each STA 115 may be assigned a group ID threshold N_{groups}_{_}ₚₑᵣ_{_}_{STA}_{_}ₘₐₓ. An AP 105 may assign STAs 115 to a group ID based at least in part on respective traffic for each STA 115. For example, the AP 105 may assign a common group ID to three STAs 115 if the three STAs 115 have packets in the queue at the same time.

Thus, an AP 105 may implement MU transmissions by grouping STAs 115 into transmissions sets assigned group IDs. In some cases, the AP 105 assigns a group ID multiple transmissions sets that are adaptively configurable; that is, a STA 115 may be paired with different STAs 115. In certain scenarios, the AP 105 assigns a STA 115 to multiple group IDs with unique transmission set (i.e., STA 115) combinations. Thus, the STA 115 may receive MU transmissions that convey data for various STAs 115. An AP 105 may determine which group ID and position to assign to a STA 115 based at least in part on grouping diversity. Grouping diversity may refer to the unique STA 115 combinations for transmission sets derived from group IDs. For example, an AP 105 may assign a STA 115 to a group ID and position if the assignment results in the maximum number of unique transmissions sets compared with any other assignment. Thus, an AP 105 may implement an algorithm that groups STAs 115 based at least in part on a grouping diversity, N_{groups}_{_}ₚₑᵣ_{_}_{STA}_{_}ₘₐₓ, and Nᵣₑᵤₛₑ_{_}ₘₐₓ.

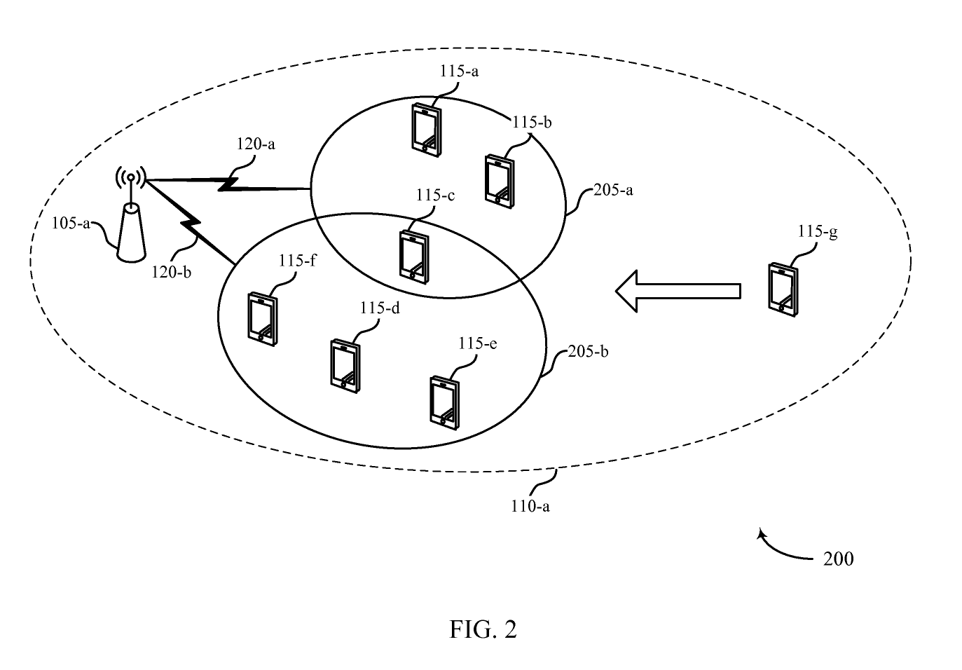

FIG. 2 illustrates an example of a wireless communications subsystem 200 that supports dynamic assignment of stations to MU group IDs in accordance with various aspects of the present disclosure. Wireless communication subsystems 200 may facilitate dynamic grouping of STAs 115 for MU transmissions. Wireless communications subsystem 200 may include AP 105-a, which may be an example of an AP 105 described with reference to FIG. 1. Wireless communications subsystem 200 may include MU group 205 and MU group 210.

Each MU group 205 may include a number of STAs 115. For example, MU group 205-a may include STA 115-a, STA 115-b, and STA 115-c. Each of the STAs in MU group 205-a may be assigned a common group ID. MU group 205-b may include STA 115-d, STA 115-e, STA 115-f, and STA 115-c. Each STA 115 in MU group 205-b may be assigned a common group ID. Thus, STA 115-c may be assigned more than one group ID.

The STAs 115 of each MU group may wake up to receive MU transmissions that include the group ID corresponding to the MU group to which the STAs 115 belong. For example, an MU transmission sent over wireless link 120-a may convey data intended for a transmission set of MU group 205-a, and thus may include the group ID assigned to MU group 205-a. Similarly, an MU transmission sent over wireless link 120-b may convey data intended for a transmission set of MU group 205-b, and thus may include the group ID assigned to MU group 205-b. A STA 115 within an MU group 205 may determine which spatial streams to demodulate based at least in part on information included in the MU transmission.

AP 105-a may assign multiple transmission sets to an MU group 205 (i.e., a group ID may include a number of STA 115 combinations for MU transmissions). For example, AP 105-a may group STA 115-c, STA 115-d, and STA 115-e as a transmission set for MU group 205-b. AP 105-a may also group STA 115-c, STA 115-d, and STA 115-f as a transmission set for MU group 205-b. Thus, various combinations of STAs 115 per MU group 205 may be grouped into transmission sets for a group ID. That is, a STA 115 may be partnered with different STAs 115 for MU transmissions. AP 105-a may dynamically configure a transmission set for an MU group 205. For example, AP 105-a may detect queued firmware data for STA 115-c, STA 115-e, and STA 115-f, and dynamically create a transmission set for STA 115-c, STA 115-e, and STA 115-f. Thus, AP 105-a convey data to STA 115-c, STA 115-e, and STA 115-f in an MU transmission with a group ID corresponding to MU group 205-b.

In some examples, AP 105-a assigns a group ID for each transmission set. That is, AP 105-a may assign a different group ID for each combination of STAs 115 within an MU group 205. Thus, a transmission set of STA 115-c, STA 115-d, and STA 115-e may be assigned a different group ID than a transmission set of STA 115-c, STA 115-d, and STA 115-f.

Wireless communications subsystem 200 may include STAs 115 that are not assigned group IDs. For example, at some point STA 115-g may enter the coverage area 110-a of AP 105-a. When AP 105-a detects STA 115-g, AP 105-a may assign STA 115-g a group ID. For example, AP 105-a may assign STA 115-g to MU group 205-a and the corresponding group ID. Additionally or alternatively, AP 105-a may assign STA 115-g to MU group 205-b and the corresponding group ID. Accordingly, STA 115-g may combined with the various STAs 115 of the MU group to which STA 115-g is assigned to form a transmission set. In certain aspects, AP 105-a assigns a new group ID to STA 115-g.

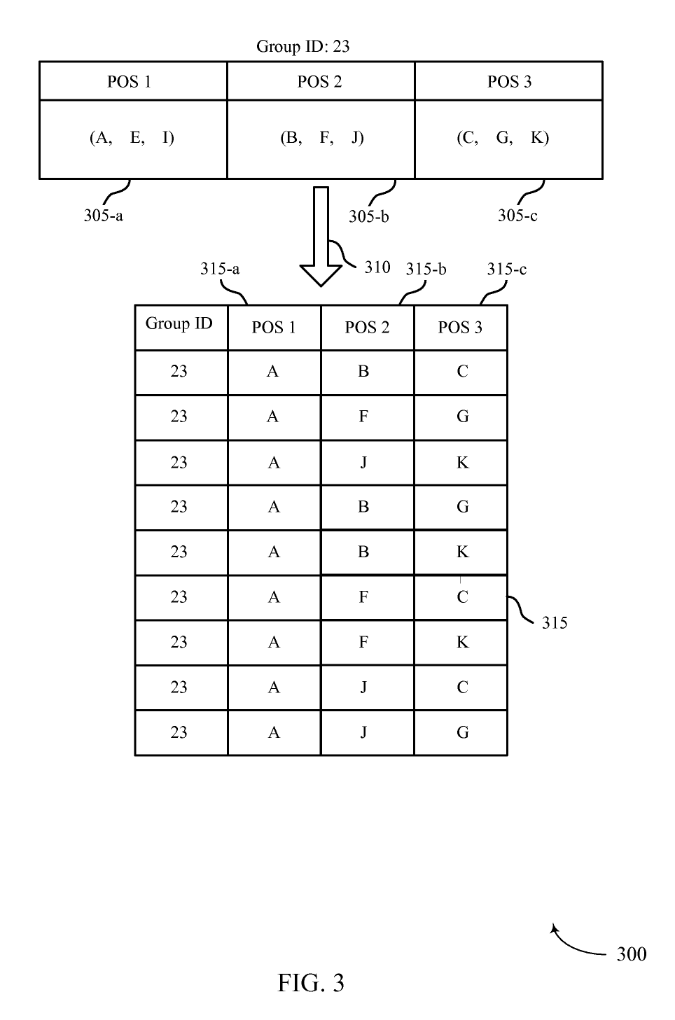

FIG. 3 illustrates an example of MU transmission sets 300 that support dynamic assignment of stations to multi-user group IDs in accordance with various aspects of the present disclosure. MU transmission sets 300 may be dynamically configured to facilitate an increase MU transmission density. MU transmission sets 300 may be determined by an AP 105 for STAs 115 as described with reference to FIGS. 1 and 2.

A group ID may be assigned to an MU group. The MU group and group ID may include three user positions, as defined by the reuse factor. Thus, an MU transmission may include data for three STAs 115 at a time. Each user position may be occupied by three stations, as defined by the Nᵣₑᵤₛₑ_{_}ₘₐₓ for each position (i.e., Nᵣₑᵤₛₑ_{_}ₘₐₓ=3 for each position 305). For example, position 1 (POS 1) 305-a of the MU group assigned group ID 23 may be occupied by STA 115 A, STA 115 E, and STA 115 I. Position 2 (POS 2) 305-b of the MU group assigned group ID 23 may be occupied by STA 115 B, STA 115 F, and STA 115 J. The Nᵣₑᵤₛₑ_{_}ₘₐₓ may be different for each position 305.

An AP 105 may create 310 MU transmission sets that include various combinations of the STAs in the MU group assigned group ID 23. In the present example, when the reuse factor is three and Nᵣₑᵤₛₑ is three, there may be nine possible transmission sets that include STA 115 A. The various combinations of STAs 115 for each transmission set that includes STA 115 A is shown in MU transmission set table 320. A transmission set may include a STA 115 from each position 315 of the MU group assigned group ID 23. Each position 310 of a transmission set may be assigned to a STA 115 that occupies the corresponding POS 1 305-a in the MU group assigned the group ID. For example, position 1 (POS 1) 315-a may be assigned to any STA 115 that occupies POS 1 305-a (e.g., STA 115 A, STA 115 E, STA 115 I), position 2 (POS 2) 315-b may be assigned to any STA 115 that occupies POS 2 305-b (e.g., STA 115 B, STA 115 F, STA 115 J), and position 3 (POS 3) 315-c may be assigned to any STA 115 that occupies position 3 (POS 3) 305-c (e.g., STA 115 C, STA 115 G, STA 115 K).

Assigning STAs 115 to the positions 305 of group ID 23 according to the threshold indicated by Nᵣₑᵤₛₑ_{_}ₘₐₓ may allow a STA 115 to be flexibly grouped with different sets of partner STAs 115. Flexibility in assignment may increase the likelihood of finding a set of partner STAS 115 (e.g., STAs 115 that have data ready to transmit) for a STA 115 assigned to group ID 23. However, larger values of Nᵣₑᵤₛₑ_{_}ₘₐₓ may result in increased energy expenditure for a STA 115. For example, a STA 115 may wake up and process any MU transmission that carries the group ID assigned to the STA 115. However, if the group ID has a large number of STAs 115 (i.e., transmission sets) permitted by Nᵣₑᵤₛₑ_{_}ₘₐₓ, the STA 115 may wake up to process a significant amount of irrelevant MU transmissions. Thus, in some cases, an AP 105 manages energy consumption of a STA 115 by restricting the number of STAs 115 that may be assigned to a position 305. That is, the AP 105 may set Nᵣₑᵤₛₑ_{_}ₘₐₓ so that energy consumption of a STA 115 is reduced (i.e., an upper bound of Nᵣₑᵤₛₑ may be set for every MU group position 305 such that Nᵣₑᵤₛₑ_{_}ₘₐₓ<Nᵣₑᵤₛₑ_{_}ₘₐₓ). Thus, the number of STA 115 combinations per group ID may be limited according to the Nᵣₑᵤₛₑ_{_}ₘₐₓ.

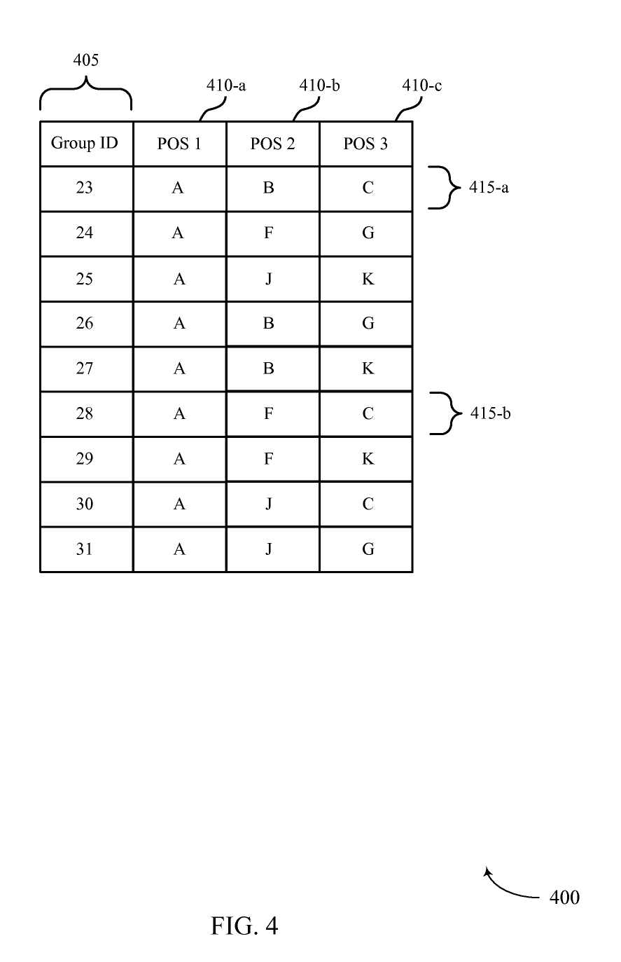

FIG. 4 illustrates an example of group IDs 400 that support dynamic assignment of stations to multi-user group IDs in accordance with various aspects of the present disclosure. Group IDs 400 may be determined by an AP 105 for STAs 115 in an MU environment. For example, group IDs 400 may represent a number of possible transmission sets for a group of STAs including: STA 115 A, STA 115 B, STA 115 C, STA 115 E, STA 115 F, STA 115 G, STA 115 I, STA 115 J, and STA 115 K.

Group IDs 400 may include a number of group IDs 405, each of which identify a unique transmission set. Each group ID may include a number of positions 410, such as defined by the reuse factor. In the present example, the reuse factor is three. However, different reuse factors may be used. A position 410 may be assigned to a STA 115. For example, for transmission set 415-a, STA 115 A may be assigned to position 1 (POS 1) 410-a, STA 115 B may be assigned to position 2 (POS 2) 410-b, and STA 115 C may be assigned to position 3 (POS 3) 410-c. Each transmission set may include a different combination of STAs 115 with respect to STA 115 A. That is, STA 115 A may be assigned to more than one group ID. However, assigning multiple group IDs to a STA 115 may increase management overhead. Accordingly, in some cases, an AP 105 limits or restricts the number of group IDs to which a STA may be assigned. That is, the AP 105 may ensure that N_{groups}_{_}ₚₑᵣ_{_}_{STA}_{_}ₘₐₓ<N_{groups}_{_}ₚₑᵣ_{_}_{STA}_{_}ₘₐₓ. In other words, the value for N_{groups}_{_}ₚₑᵣ_{_}_{STA}_{_}ₘₐₓ may be selected based at least in part on reducing management overhead. Thus, in the present example, when N_{groups}_{_}ₚₑᵣ_{_}_{STA} is nine for STA A, nine different transmission sets may be defined.

An AP 105 may monitor transmission queues for data corresponding to STAs 115. Based at least in part on the packets pending, the AP 105 may create a transmission set and assign the transmission set a group ID. For example, the AP 105 may detect that STA 115 A, STA 115 F, and STA 115 C each have data available for transmission. Accordingly, the AP 105 may create transmission set 415-b, which includes STA 115 A, STA 115 F, and STA 115 C, and is assigned group ID 28. In certain aspects, an AP 105 may dismiss (or create) a transmission set based at least in part on the traffic history of the STAs 115 associated with the transmission set. For example, the AP 105 may monitor firmware queues and dismiss a transmission set if the STAs 115 within the transmission set rarely have data pending at the same time. For example, the AP 105 may detect that a transmission set historically waits for one or more STAs 115 within the transmission set to have available data before sending an MU transmission. Once a transmission set has been created, the AP 105 may dynamically add or remove STAs 115 to or from the transmission set.

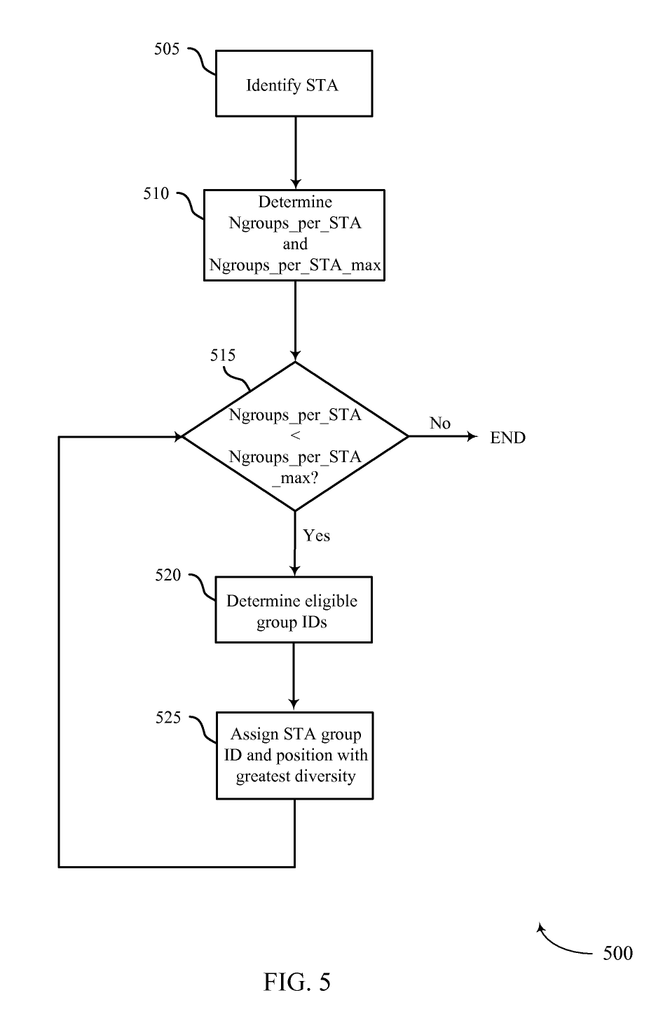

FIG. 5 illustrates an example of a flow chart 500 for dynamic assignment of stations to multi-user group IDs in accordance with various aspects of the present disclosure. Flow chart 500 may be implemented by an AP 105 such as described with reference to FIGS. 1-4. Flow chart 500 may facilitate the process of assigning a STA 115 to a group ID, as described herein and with reference to FIGS. 1-4.

At 505, an AP 105 may identify a STA 115 that capable of supporting MU transmissions. At 510, the AP 105 may determine N_{groups}_{_}ₚₑᵣ_{_}_{STA} (i.e., the current number of group IDs assigned to the STA 115) and N_{groups}_{_}ₚₑᵣ_{_}_{STA}_{_}ₘₐₓ for the STA 115. At 515, the AP 105 may compare N_{groups}_{_}ₚₑᵣ_{_}_{STA} of the STA 115 to N_{groups}_{_}ₚₑᵣ_{_}_{STA}_{_}ₘₐₓ of the STA 115. Based at least in part on the comparison, the AP 105 may determine if N_{groups}_{_}ₚₑᵣ_{_}_{STA} is less than N_{groups}_{_}ₚₑᵣ_{_}_{STA}_{_}ₘₐₓ. If N_{groups}_{_}ₚₑᵣ_{_}_{STA} is not less than N_{groups}_{_}ₚₑᵣ_{_}_{STA}_{_}ₘₐₓ, (e.g., N_{groups}_{_}ₚₑᵣ_{_}_{STA}_{_}ₘₐₓ is equal to N_{groups}_{_}ₚₑᵣ_{_}_{STA}_{_}ₘₐₓ), the AP 105 may cease assigning group IDs to the STA 115. In some cases, the AP 105 may return to 505 and identify a new STA 115 to assign. If N_{groups}_{_}ₚₑᵣ_{_}_{STA} is less than N_{groups}_{_}ₚₑᵣ_{_}_{STA}_{_}ₘₐₓ, (i.e., the STA 115 has not maxed out its group ID quota) the AP 105 may proceed to 520.

At 520, the AP 105 may determine eligible group IDs for STA 115. A group ID may be eligible for assignment if the group ID has at least one position available for assignment (e.g., the position has Nᵣₑᵤₛₑ<Nᵣₑᵤₛₑ_{_}ₘₐₓ). At 525, the AP 105 may assign the STA 115 to the group ID and position that gives the greatest group diversity. That is, the AP 105 may assign the STA 115 to a group ID and position that results in the greatest number of unique STA 115 combinations. After assigning the STA 115 to the group ID and position, the AP 105 may cease assigning group IDs to the STA 115. In some cases, the AP 105 may return to 505 and identify a new STA 115 to assign.

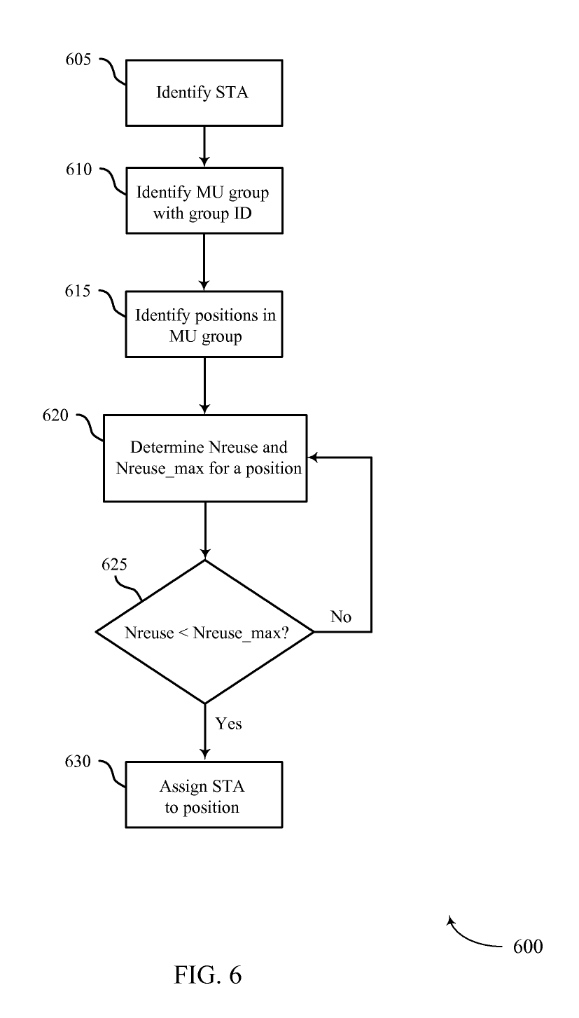

FIG. 6 illustrates an example of a flow chart 600 for dynamic assignment of stations to multi-user group IDs in accordance with various aspects of the present disclosure. Flow chart 600 may be implemented by an AP 105 such as described with reference to FIGS. 1-4. Flow chart 600 may facilitate the process of assigning STAs 115 to an MU group position, as described herein and with reference to FIGS. 1-4.

At 605, an AP 105 may identify a STA 115 that is capable of supporting MU transmissions. The AP 105 may determine that the STA 115 is eligible for assignment to a group ID and position (e.g., N_{groups}_{_}ₚₑᵣ_{_}_{STA}<N_{groups}_{_}ₚₑᵣ_{_}_{STA}_{_}ₘₐₓ). At 610, the AP 105 may identify an MU group assigned a group ID. At 615, the AP 105 may identify a number of positions in the MU group. The number of positions may be indicated by the reuse factor for the group ID. At 620, the AP 105 may determine Nᵣₑᵤₛₑ and Nᵣₑᵤₛₑ_{_}ₘₐₓ for a position in the MU group. The position may be selected based at least in part on the grouping diversity. At 625, the AP 105 may compare Nᵣₑᵤₛₑ for the position with Nᵣₑᵤₛₑ_{_}ₘₐₓ for the position. Accordingly, the AP 105 may determine if Nᵣₑᵤₛₑ for the position is less than Nᵣₑᵤₛₑ_{_}ₘₐₓ for the position. If Nᵣₑᵤₛₑ for the position is not less than Nᵣₑᵤₛₑ_{_}ₘₐₓ for the position, the AP 105 may return to 620 and determine Nᵣₑᵤₛₑ and Nᵣₑᵤₛₑ_{_}ₘₐₓ for a new position. If Nᵣₑᵤₛₑ for the position is less than Nᵣₑᵤₛₑ_{_}ₘₐₓ for the position, the AP 105 may proceed to 630. At 630, the AP 105 may the STA 115 to the position. Thus, an AP 105 may assign STAs 115 to positions within an MU group based at least in part on the number of STAs 115 permitted to be assigned to each position.

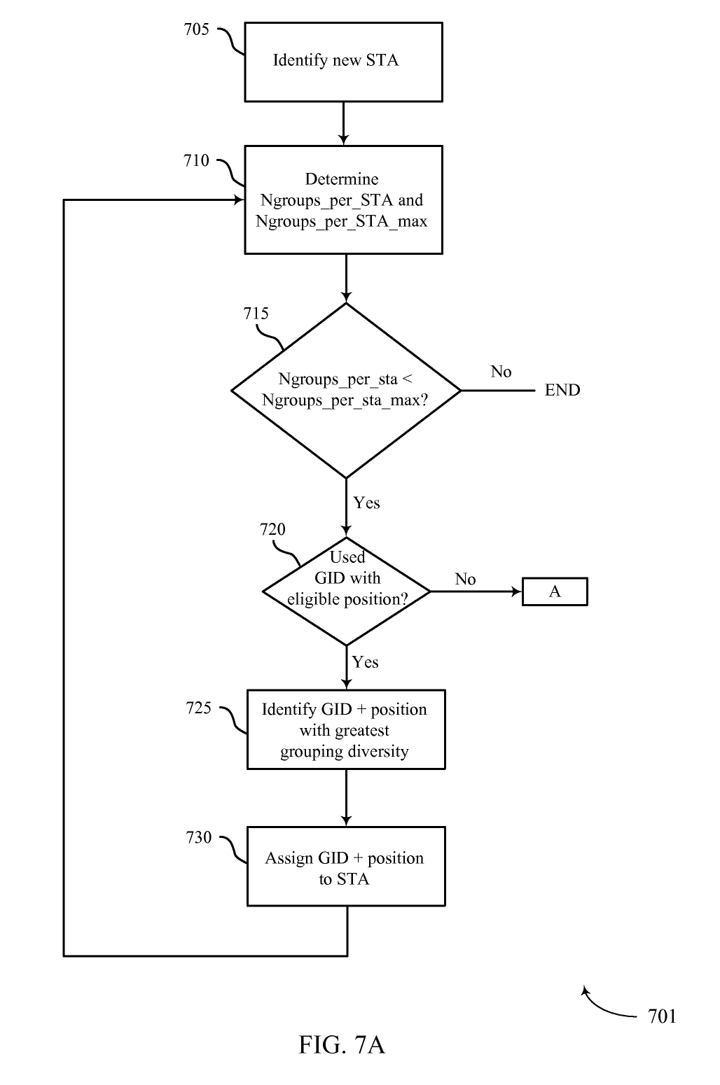

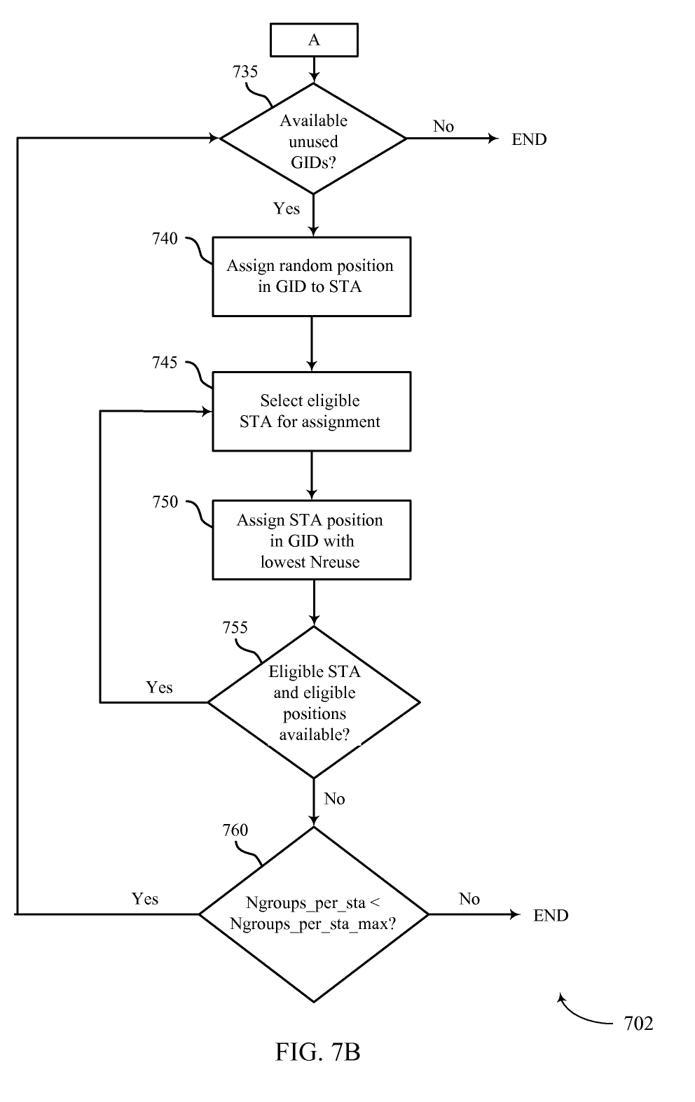

FIG. 7A illustrates an example of a flow chart 700 for dynamic assignment of stations to multi-user group IDs in accordance with various aspects of the present disclosure. Flow chart 700 may be implemented by an AP 105 to assign a STA 115 to an MU group according to the greatest group diversity. Flow chart 700 may take advantage of group ID reuse and position reuse as described with reference to FIGS. 1-6.

At 705, an AP 105 may identify a STA 115 capable of supporting MU communications. At 710, the AP 105 may determine N_{groups}_{_}ₚₑᵣ_{_}_{STA} and N_{groups}_{_}ₚₑᵣ_{_}_{STA}_{_}ₘₐₓ for the STA 115. At 715, the AP 105 may determine if N_{groups}_{_}ₚₑᵣ_{_}_{STA} is less than N_{groups}_{_}ₚₑᵣ_{_}_{STA}_{_}ₘₐₓ. If N_{groups}_{_}ₚₑᵣ_{_}_{STA} is not less than N_{groups}_{_}ₚₑᵣ_{_}_{STA}_{_}ₘₐₓ, (i.e., the STA 115 is assigned to the maximum number of group IDs (GIDs)) the AP 105 may cease assigning the STA 115 GIDs. In some cases, the AP 105 may return to 705 and identify a new STA 115. However, if N_{groups}_{_}ₚₑᵣ_{_}_{STA} is less than N_{groups}_{_}ₚₑᵣ_{_}_{STA}_{_}ₘₐₓ (i.e. the STA 115 is not assigned to the maximum number of GIDs), the AP 105 may proceed to 720.

At 720, the AP 105 may determine if there are any used GIDs (i.e., GIDs that are assigned at least one STA 115) with eligible positions available. For example, the AP 105 may determine if a GID has a position with Nᵣₑᵤₛₑ<Nᵣₑᵤₛₑ_{_}ₘₐₓ (i.e., the position is not assigned to the maximum number of permitted STAs 115). If a there exists a used GID with an eligible position, the AP 105 may proceed to 725. At 725, the AP 105 may determine which GID and position gives the greatest grouping diversity. For instance, the AP 105 may determine which GID and position, if assigned the STA 115, would result in the greatest number of possible unique STA 115 combinations (or transmission sets). At 730, the AP 105 may assign the STA 115 to the GID and position that give the greatest grouping diversity. After assigning the STA 115 to the GID and position, the AP 105 may return to 710 to determine the updated N_{groups}_{_}ₚₑᵣ_{_}_{STA} for the STA 115.

At 720, if there does not exist a used GID with an eligible position, the AP may proceed to A, which is the beginning point for the process of the AP 105 assigning the STA 115 an unused GID, as depicted in FIG. 7B. At 735, the AP 105 may determine if there are any unused GIDs (e.g., GIDs that do not have any STAs 115 assigned) available for assignment. If there are no available GIDs (e.g., all of the GIDs have been assigned), the AP 105 may pause or cease the assigning process until a GID (used or unused) becomes available. If there is an available unused GID the AP 105 may proceed to 740.

At 740, the AP 105 may assign a random position in an eligible unused GID. The AP 105 may then fill the remaining positions of the unused GID by assigning STAs 115 from used GIDs. For example, at 745, the AP 105 may select an eligible STA 115 for assignment to the GID. A STA 115 may be eligible if it has not used up its quota of occupying multiple group IDs (i.e., N_{groups}_{_}ₚₑᵣ_{_}_{STA}<N_{groups}_{_}ₚₑᵣ_{_}_{STA}_{_}ₘₐₓ). A STA 115 may be ineligible for assignment if assignment of the STA 115 to the position in the GID creates a duplication of an existing transmission set. In one example, a STA 115 may not be permitted to be assigned to a GID if the assignment results in the STA 115 being partnered with another STA 115 in more than one GID. For example, two STAs 115 may be restricted from being occupying transmission sets that include the same combination of STAs 115. In some cases, the STA 115 is selected sequentially from different MU group with a different GID, starting with the first position. However, other methods of selection may be implemented, including selecting STAs 115 based at least in part on communication parameters (e.g., modulation and coding scheme (MCS), traffic load level, traffic priority, etc.). Traffic priority may determine by the access category of the STA 115. In some scenarios, the STAs 115 with the smallest grouping diversity degree (e.g. those with the least number of unique partner STA 115 combinations) are selected first. In this or other examples, the STAs 115 with the smallest values of N_{groups}_{_}ₚₑᵣ_{_}_{STA}_{_}ₘₐₓ may be selected for assignment before the STAs 115 with larger values of N_{groups}_{_}ₚₑᵣ_{_}_{STA}_{_}ₘₐₓ.

At 750, the AP 105 may assign the selected STA 115 to a position in the GID that has the lowest Nᵣₑᵤₛₑ. At 755, the AP 105 may determine if there are eligible STAs 115 and eligible positions in the GID for assignment. If there exists an eligible STA 115 and an eligible position, the AP may proceed to 745. If an eligible STA 115 or an eligible position does not exist, the AP 105 may proceed to 760. At 760, the AP 105 may determine if the STA 115 has N_{groups}_{_}ₚₑᵣ_{_}_{STA}<N_{groups}_{_}ₚₑᵣ_{_}_{STA}_{_}ₘₐₓ (i.e., the AP 105 may determine if the STA 115 has been assigned the maximum number of group IDs permitted). If N_{groups}_{_}ₚₑᵣ_{_}_{STA} is less than N_{groups}_{_}ₚₑᵣ_{_}_{STA}_{_}ₘₐₓ, the AP 105 may return to 735. If N_{groups}_{_}ₚₑᵣ_{_}_{STA} is not less than N_{groups}_{_}ₚₑᵣ_{_}_{STA}_{_}ₘₐₓ, the AP 105 may proceed stop the assigning process or return to 705.

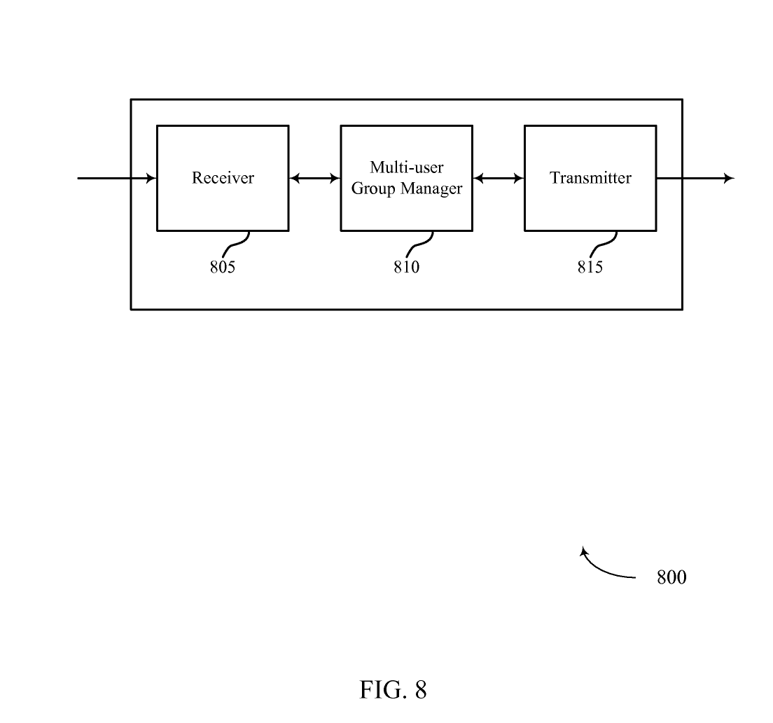

FIG. 8 shows a block diagram of a wireless device 800 configured for dynamic assignment of stations to multi-user group IDs in accordance with various aspects of the present disclosure. Wireless device 800 may be an example of aspects of an AP 105 described with reference to FIGS. 1-7B. Wireless device 800 may include a receiver 805, a multi-user group manager 810, or a transmitter 815. Wireless device 800 may also include a processor. Each of these components may be in communication with each other.

The receiver 805 may receive information such as packets, user data, or control information associated with various information channels (e.g., control channels, data channels, and information related to dynamic assignment of stations to multi-user group IDs, etc.). Information may be passed on to the multi-user group manager 810, and to other components of wireless device 800. The multi-user group manager 810 may identify a plurality of stations. Each station may support multi-user transmissions (e.g., MU-N transmissions). The multi-user group manager 810 may determine a group identifier (ID) threshold for each station. The group ID threshold may indicate a maximum number of group IDs that may be assigned to each station. The multi-user group manager 810 may assign each station to a group ID based at least in part on the group ID threshold associated with each station. The transmitter 815 may transmit signals received from other components of wireless device 800. In some examples, the transmitter 815 may be collocated with the receiver 805 in a transceiver module. The transmitter 815 may include a single antenna, or it may include a plurality of antennas.

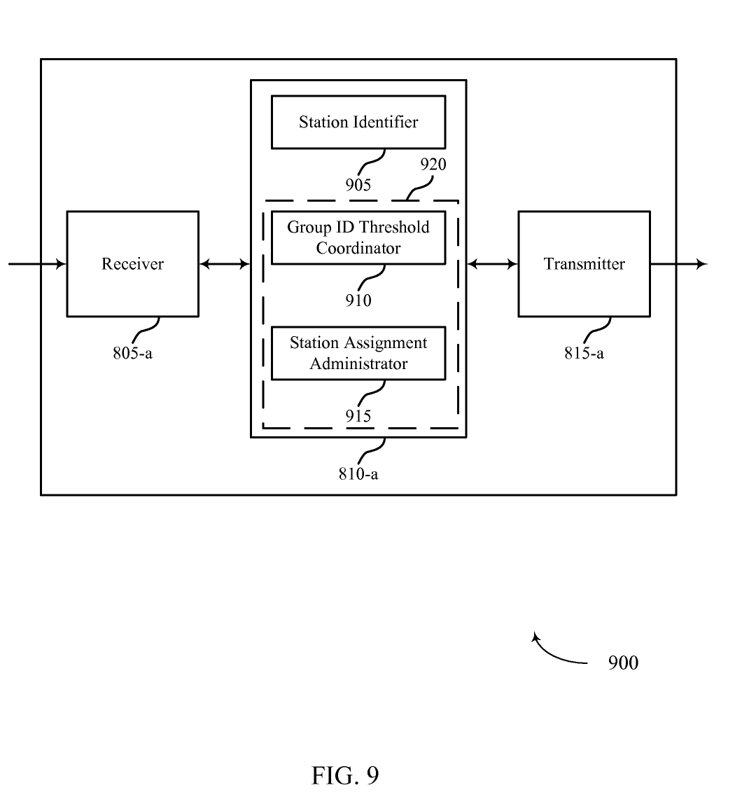

FIG. 9 shows a block diagram of a wireless device 900 for dynamic assignment of stations to multi-user group IDs in accordance with various aspects of the present disclosure. Wireless device 900 may be an example of aspects of a wireless device 800 or an AP 105 described with reference to FIGS. 1-8. Wireless device 900 may include a receiver 805-a, a multi-user group manager 810-a, or a transmitter 815-a. Wireless device 900 may also include a processor. Each of these components may be in communication with each other. Alternative or additional to FIG. 8, the multi-user group manager 810-a may include a station identifier 905, a group ID threshold coordinator 910, and a station assignment administrator 915. In some cases, the group ID threshold coordinator 910 and the station assignment administrator 915 are included in a MU group identification manager 920 which may identify a multi-user group that includes a number of positions.

The receiver 805-a may receive information which may be passed on to multi-user group manager 810-a, and to other components of wireless device 900. The multi-user group manager 810-a may perform the operations described with reference to FIG. 8. The transmitter 815-a may transmit signals received from other components of wireless device 900. The station identifier 905 may identify a plurality of stations, wherein each station of the plurality of stations supports multi-user transmissions as described with reference to FIGS. 2-7B. The station identifier 905 may also identify a plurality of stations that support multi-user transmissions. In some cases, the station identifier 905 may also identify a new station that supports multi-user transmissions.

The group ID threshold coordinator 910 may determine a group identifier (ID) threshold (which may also be referred to herein as N_{groups}_{_}ₚₑᵣ_{_}_{STA}_{_}ₘₐₓ) for each station. The group ID threshold may indicate a maximum number of group IDs that may be assigned to each station as described with reference to FIGS. 2-7B. The group ID threshold may be determined based at least in part on overhead associated with MU transmissions for the group ID. In some examples, assigning each station includes determining a number of group IDs to which the station is assigned (i.e., N_{groups}_{_}ₚₑᵣ_{_}_{STA}). The group ID threshold coordinator 910 may also determine that the number of group IDs is less than the group ID threshold for the station (i.e., N_{groups}_{_}ₚₑᵣ_{_}_{STA}<N_{groups}_{_}ₚₑᵣ_{_}_{STA}_{_}ₘₐₓ). The group ID threshold coordinator 910 may also identify a plurality of group identifiers (IDs). Each group ID may have a plurality of positions. In some cases, each station is assigned to a position of the plurality of positions based at least in part on a group ID threshold associated with the station and a reuse threshold applicable to the position. The group ID threshold coordinator 910 may assign a new group ID threshold to a new station.

The station assignment administrator 915 may assign each station to a group ID based at least in part on the group ID threshold associated with each station as described with reference to FIGS. 2-7B. The station assignment administrator 915 may also assign a station to an additional group ID of the plurality of group IDs. In certain cases, the station assignment administrator 915 disassociates a group of stations from a group ID. The station assignment administrator 915 may also assign a station of the plurality of stations to a position in the group ID. In certain scenarios, the station assignment administrator 915 assigns a station to a position based at least in part on the reuse threshold (i.e., Nᵣₑᵤₛₑ_{_}ₘₐₓ) for the position. In some cases, the station assignment administrator 915 may assign a station to each position of a plurality of positions in a group ID.

In some aspects, the station assignment administrator 915 may select one station assigned to each position of the multi-user group. The station assignment administrator 915 may group the selected stations into a transmission set. In some examples, if data is available for each station in the transmission set, the station assignment administrator 915 may facilitate transmission of an MU transmission to the transmission set. The MU transmission may include the group ID to which the stations in the transmission set are assigned. If a new station is detected, the station assignment administrator 915 may assign the new station to an available position of a group ID. The assignment may be subject to the reuse threshold applicable to the position and the group ID threshold for the station. In some cases, the station assignment administrator 915 may also assign the new station to a position and group ID based at least in part on a grouping diversity of the group ID to which the new station is assigned.

In certain scenarios, the station assignment administrator 915 assigns the new station to a new group ID having a plurality of new positions. A group ID may be new if the group ID has not yet been assigned to any stations. The station assignment administrator 915 may assign the new station to a random position of the new group ID. In some cases, the station assignment administrator 915 may sequentially select stations to assign to the positions of the new group ID. The assignment of the stations to the positions may be subject to the group ID threshold for each station and the reuse threshold assigned to the positions. In certain examples, a unique combination of stations is assigned to each position of the plurality of positions.

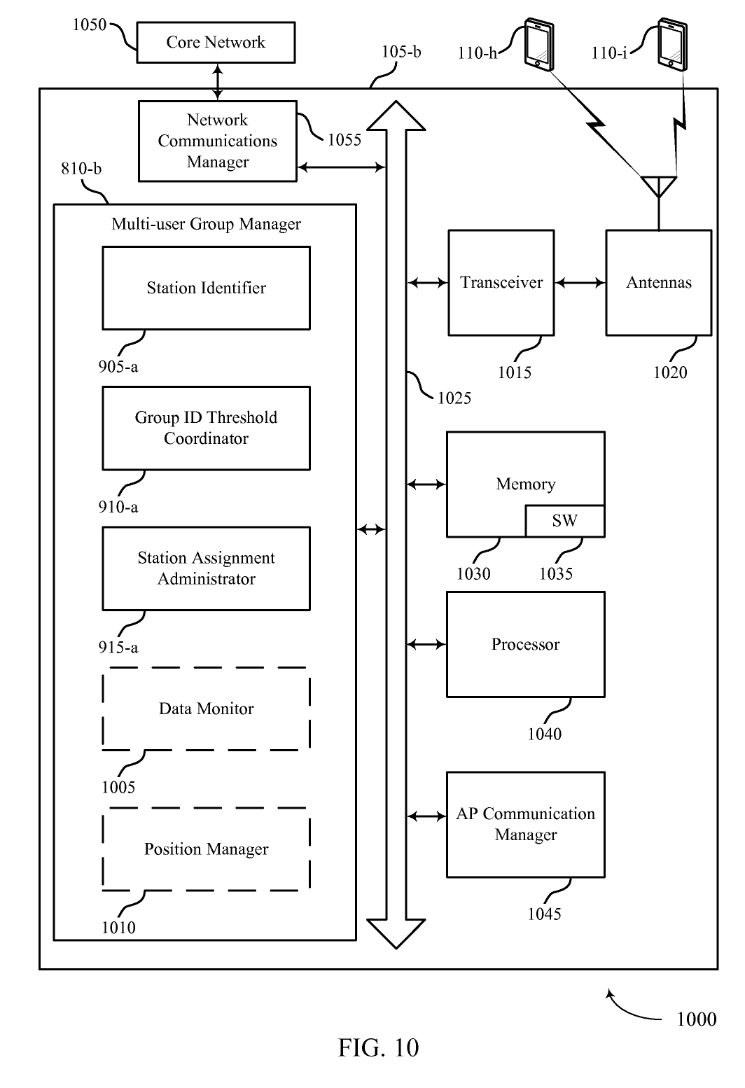

FIG. 10 shows a diagram of a system 1000 including AP 105-b configured for dynamic assignment of stations to multi-user group IDs in accordance with various aspects of the present disclosure. AP 105-b may be an example of a wireless device 800, a wireless device 900, or an AP 105 described with reference to FIGS. 1-9. AP 105-b may include a multi-user group manager 810-b, which may be an example of a multi-user group manager 810 or 810-a described with reference to FIGS. 8 and 9. The multi-user group manager 810-b may include a station identifier 905-a, a group ID threshold coordinator 910-a, and a station assignment administrator 915-a. Each of these modules may implement the features described with reference to FIG. 9. The multi-user group manager 810-b may also include a data monitor 1005, and a position manager 1010. AP 105-b may also include components for bi-directional voice and data communications including components for transmitting communications and components for receiving communications. For example, AP 105-b may communicate bi-directionally with STA 115-h or STA 115-i. For instance, AP 105-b may send MU transmissions to STA 115-h or STA 115-i. Thus, STA 115-h and STA 115-i may each be capable of supporting MU transmissions.

The transceiver 1015 may communicate bi-directionally, via the antenna(s) 1020 or wired or wireless links, with one or more networks, as described above. For example, the transceiver 1015 may communicate bi-directionally with an AP 105 or another STA 115. The transceiver 1015 may include a modem to modulate the packets and provide the modulated packets to the antenna(s) 1020 for transmission, and to demodulate packets received from the antenna(s) 1020. While AP 105-b may include a single antenna 1020, AP 105-b may also have multiple antennas 1020 capable of concurrently transmitting or receiving multiple wireless transmissions. Each of the APs 105 may communicate with STAs 115 using the same or different wireless communications technologies. In some cases, AP 105-b may communicate with other APs utilizing AP communication manager 1045. In some cases, AP 105-b may communicate with the core network 1050 through network communications manager 1055.

The data monitor 1005 may determine which stations have data ready for transmission. For example, data monitor 1005 may monitor data transmission queues associated with MU stations assigned to a group ID. Based at least in part on the packets pending at the queue, the data monitor 1005 may determine whether a station has data ready for transmission. Accordingly, a station may be assigned (e.g., by station assignment administrator 915-a) to a group ID or transmission set based at least in part on the determination that the station has queued data, as described with reference to FIGS. 2-7. In some cases, the data monitor 1005 may also determine that a group ID is assigned to a group of stations with insufficient data for a multi-user transmission. In such a scenario, the transmission set or group may be dissolved. For example, the station assignment administrator 915-a may disassociate the group of stations from the group ID.

The position manager 1010 may identify a multi-user group that includes a plurality of positions, as described with reference to FIGS. 2-7. The position manager 1010 may determine a reuse threshold (i.e., Nᵣₑᵤₛₑ_{_}ₘₐₓ) for each position in the multi-user group. The reuse threshold may indicate the maximum number of stations which may be assigned to the position. In some examples, the reuse threshold is based at least in part on energy consumption management. In certain aspects, the position manager 1010 identifies a number of stations assigned to a position. The position manager 1010 may compare the number of stations assigned to the position to the reuse threshold for the position. Based at least in part on the comparison, the position manager 1010 may determine that the number of stations assigned to the position is less than the reuse threshold. Accordingly, the station assignment administrator 915-a may assign a station to the position based at least in part on the reuse threshold for the position. In some cases, the position manager 1010 assigns a reuse threshold to each position in a new group ID. The reuse threshold may be based at least in part on the energy consumption of the stations associated with the group ID.

AP 105-b may also include a processor 1040 and memory 1030 (including software (SW) 1035. The memory 1030 may include random access memory (RAM) and read only memory (ROM). The memory 1030 may store computer-readable, computer-executable software/firmware code 1035 including instructions that, when executed, cause the processor 1040 to implement various features described herein (e.g., dynamic assignment of stations to multi-user group IDs, etc.). Alternatively, the software/firmware code 1035 may not be directly executable by the processor 1040 but cause a computer (e.g., when compiled and executed) to implement features described herein. The processor 1040 may include an intelligent hardware device, (e.g., a central processing unit (CPU), a microcontroller, an application specific integrated circuit (ASIC), etc.).

The components of AP 105-b and multi-user group manager 810-b may, individually or collectively, be implemented with at least one ASIC adapted to perform some or all of the applicable features in hardware. Alternatively, the features may be implemented by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The features of each unit may also be implemented, in whole or in part, with instructions embodied in a memory, formatted to be executed by one or more general or application-specific processors.

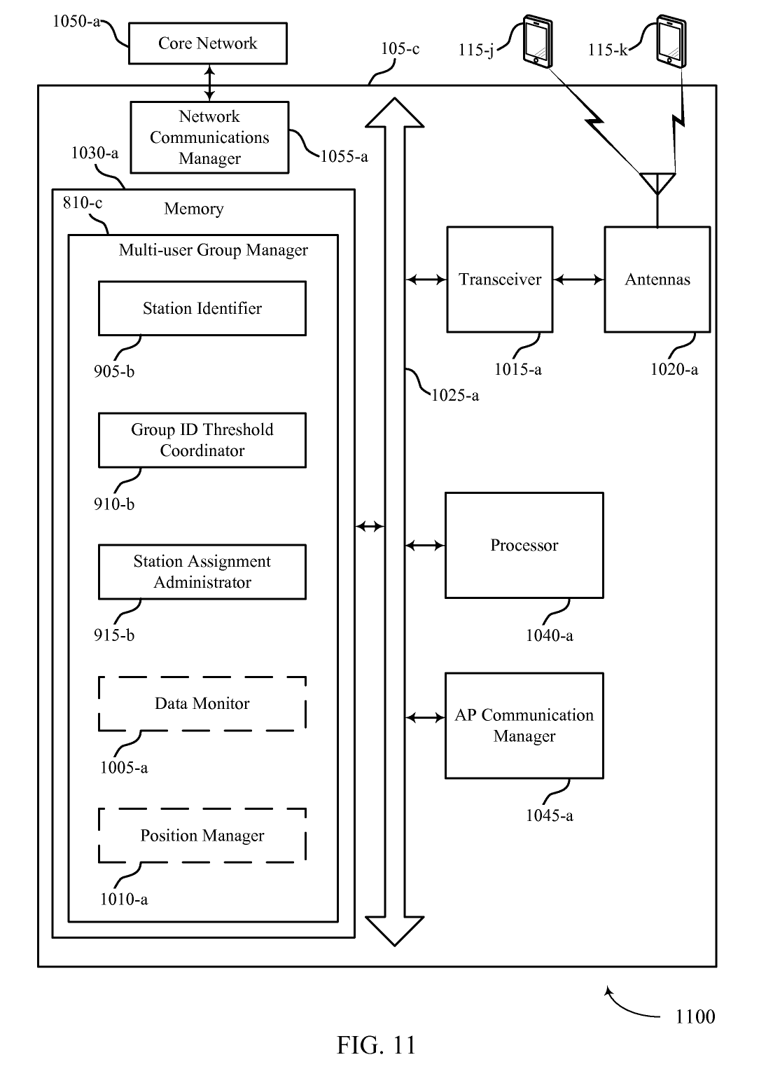

FIG. 11 shows a diagram of a system 1100 including AP 105-c configured for dynamic assignment of stations to multi-user group IDs in accordance with various aspects of the present disclosure. AP 105-c may be an example of a wireless device 800, a wireless device 900, or an AP 105 described with reference to FIGS. 1-10. AP 105-c may include a multi-user group manager 810-c, which may be an example of a multi-user group manager 810, 810-a, or 810-b described with reference to FIGS. 8, 9, and 10. AP 105-c may include a processor 1040-a, memory 1030-a, transceiver 1015-a, and antenna(s) 1020-a, each of which may implement the features described above with reference to FIG. 10, and each of which may communicate, directly or indirectly, with one another (e.g., via bus system 1025-a).

In the present example, the memory 1030-a may include software that implements the features of multi-user group manager 810-c. For example, memory 1030-a may include software that, when compiled and executed, implements the features of the station identifier 905-b, group ID threshold coordinator 910-b, station assignment administrator 915-b, data monitor 1005-a, and position manager 1010-a, such as described with reference to FIGS. 8-10. In some cases, a subset of the features of multi-user group manager 810-c is included in memory 1030-a; in other cases, all of the features may be implemented as software executed by the processor 1040-a to cause AP 105-c to perform the features of multi-user group manager 810-c. For example, the features of the station identifier 905-b and group ID threshold coordinator 910-b may be implemented by software included the memory 1030-a, while the features of station assignment administrator 915-b, data monitor 1005-a, and position manager 1010-a may be implemented using hardware. Regardless of the distribution of features, AP 105-c may dynamically assign stations to flexible mixed group transmission sets and group IDs.

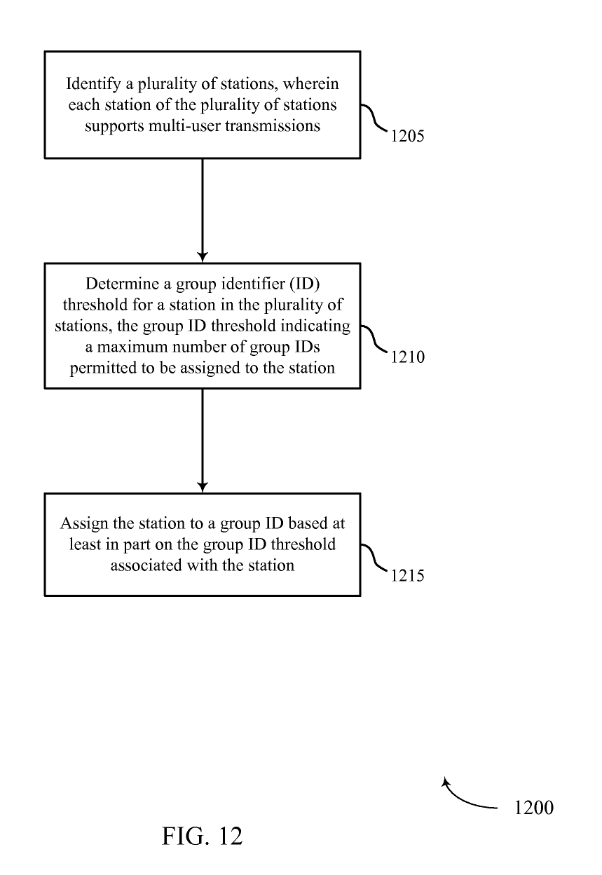

FIG. 12 shows a flowchart illustrating a method 1200 for dynamic assignment of stations to multi-user group IDs in accordance with various aspects of the present disclosure. The operations of method 1200 may be implemented by an AP 105 or its components as described with reference to FIGS. 1-11. For example, the operations of method 1200 may be performed by the multi-user group manager 810 as described with reference to FIGS. 8-11. In some examples, an AP 105 executes a set of codes to control the AP 105 to implement the features described below. Additionally or alternatively, the AP 105 may implement aspects the features described below using special-purpose hardware.

At block 1205, the AP 105 identifies a plurality of stations. Each station of the plurality of stations may support multi-user transmissions as described with reference to FIGS. 2-7. In certain examples, the operations of block 1205 are performed by the station identifier 905 as described with reference to FIG. 9. Proceeding to block 1210, the AP 105 determines a group ID threshold for a station in the plurality of stations. The group ID threshold may indicate a maximum number of group IDs permitted to be assigned to the station as described with reference to FIGS. 2-7. For example, the AP 105 may determine N_{groups}_{_}ₚₑᵣ_{_}_{STA}_{_}ₘₐₓ for the station. In some cases, the AP 105 determines the group ID threshold based at least in part on overhead associated with the MU transmissions. In certain examples, the operations of block 1210 are performed by the group ID threshold coordinator 910 as described with reference to FIG. 9. At block 1215, the AP 105 assigns the station to a group ID based at least in part on the group ID threshold associated with the station as described with reference to FIGS. 2-7. In some cases, the station is assigned a group ID that includes other stations that have data ready to transmit. In certain examples, the operations of block 1215 are performed by the station assignment administrator 915 as described with reference to FIG. 9.

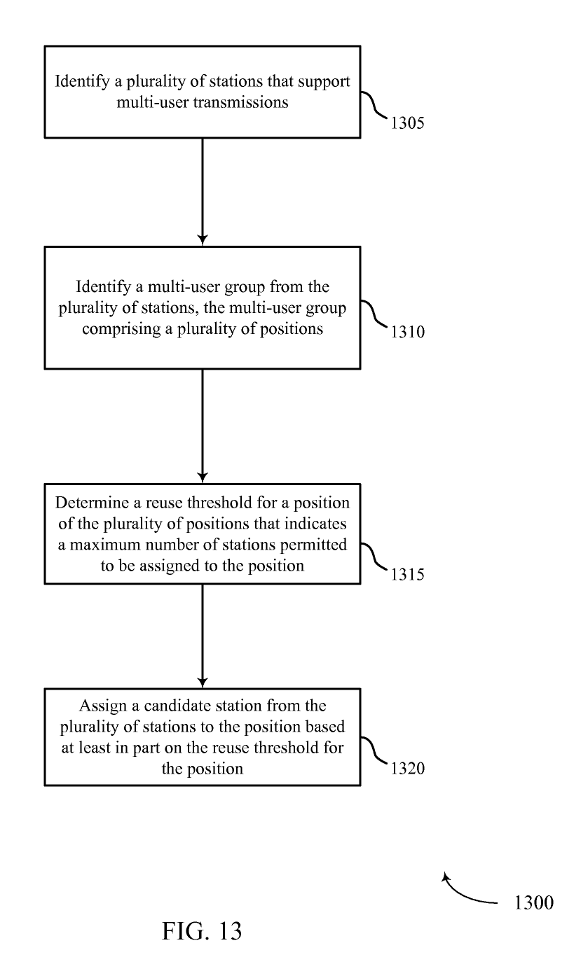

FIG. 13 shows a flowchart illustrating a method 1300 for dynamic assignment of stations to multi-user group IDs in accordance with various aspects of the present disclosure. The operations of method 1300 may be implemented by an AP 105 or its components as described with reference to FIGS. 1-11. For example, the operations of method 1300 may be performed by the multi-user group manager 810 as described with reference to FIGS. 8-11. In some examples, an AP 105 executes a set of codes to control the AP 105 to implement the features described below. Additionally or alternatively, the AP 105 may implement aspects the features described below using special-purpose hardware. The method 1300 may also incorporate aspects of method 1200 of FIG. 12.

At block 1305, the AP 105 identifies a plurality of stations that support multi-user transmissions as described with reference to FIGS. 2-7. The AP 105 may identify the stations via communications with the stations or another AP 105. In certain examples, the operations of block 1305 may be performed by the station identifier 905 as described with reference to FIG. 9. At block 1310, the AP 105 identifies a multi-user group from the plurality of stations, the multi-user group comprising a plurality of positions as described with reference to FIGS. 2-7. The multi-user group may be assigned a group ID. In certain examples, the operations of block 1310 are performed by the position manager 1010 as described with reference to FIG. 10.

At block 1315, the AP 105 determines a reuse threshold for a position of the plurality of positions that indicates a maximum number of stations permitted to be assigned to the position as described with reference to FIGS. 2-7. The AP 105 may determine the reuse threshold based at least in part on energy consumption management. In certain examples, the operations of block 1315 may be performed by the position manager 1010 as described with reference to FIG. 10. At block 1320, the AP 105 assigns a candidate station from the plurality of stations to the position based at least in part on the reuse threshold for the position as described with reference to FIGS. 2-7. In some cases, the station may be assigned to the position that gives the greatest grouping diversity. In certain examples, the operations of block 1320 are performed by the station assignment administrator 915 as described with reference to FIG. 9.

It should be noted that methods 1200 and 1300 describe possible implementations. The operations and blocks may be rearranged or otherwise modified such that other implementations are possible. Aspects from two or more of the methods 1200 and 1300 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to implement the features described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The features described herein may be implemented in hardware, software executed by a processor, firmware, or any combination thereof. If implemented in software executed by a processor, the features may be stored on or transmitted over as one or more instructions or code on a computer-readable medium. Other examples and implementations are within the scope of the disclosure and appended claims. For example, due to the nature of software, features described above can be implemented using software executed by a processor, hardware, firmware, hardwiring, or combinations of any of these. Features may also be physically located at various positions, including being distributed such that portions of features are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication by an access point (AP), comprising:
identifying by the AP a plurality of stations, wherein each station of the plurality of stations supports multi-user transmissions;
determining a group identifier (ID) threshold for a station in the plurality of stations, the group ID threshold indicating a maximum number of group IDs permitted to be assigned to the station; and
assigning the station to a group ID based at least in part on the group ID threshold associated with the station.

2. The method of claim 1, wherein assigning the station to the group ID comprises:
determining a number of group IDs to which the station is assigned; and
if the number of group IDs is less than the group ID threshold, assigning the station to the group ID.

3. The method of claim 1, wherein assigning the station to the group ID further comprises determining that the station has data ready for transmission.

4. The method of claim 3, further comprising:
monitoring a data transmission queue associated with each of the stations assigned to the group ID to determine whether that station has data ready for transmission.

5. The method of claim 1, further comprising:
determining another group ID is assigned to the station, wherein a group of stations associated with the other group ID has insufficient data for a multi-user transmission; and
disassociating the station from the group ID.

6. The method of claim 1, wherein assigning the station to the group ID is further based at least in part on a modulation and coding scheme (MCS) of the station such that a group of stations from the plurality of stations associated with the group ID have the same MCS.

7. The method of claim 1, wherein assigning the station to the group ID is further based at least in part on a traffic priority of the station.

8. The method of claim 1, further comprising:
identifying a plurality of positions for the group ID; and
assigning the station to the group ID further comprises assigning the station to an available position of the plurality of positions based at least in part on a reuse threshold applicable to the available position.

9. The method of claim 1, wherein assigning the station to the group ID is based at least in part on a grouping diversity of the group ID to which the station is assigned.

10. The method of claim 8, wherein assigning comprises randomly assigning.

11. The method of claim 8, further comprising:
assigning sequentially a plurality of new stations to the plurality of positions, wherein the plurality of new stations are associated with a set of group ID thresholds, and wherein a set of reuse thresholds are applicable to the plurality of positions.

12. The method of claim 8, wherein a unique combination of stations is assigned to each position of the plurality of positions.

13. A communication device for wireless communication, comprising:
a station identifier to identify a plurality of stations, wherein each station of the plurality of stations supports multi-user transmissions;
a group identifier (ID) threshold coordinator to determine a group identifier (ID) threshold for a station in the plurality of stations, the group ID threshold indicating a maximum number of group IDs permitted to be assigned to the station; and
a station assignment administrator to assign the station to a group ID based at least in part on the group ID threshold associated with the station.

14. The communication device of claim 13, wherein the station assignment administrator is configured to:
determine a number of group IDs to which the station is assigned; and
assign the station to the group ID if the number of group IDs is less than the group ID threshold.

15. The communication device of claim 13, further comprising:
a data monitor to determine that the station has data ready for transmission, wherein assigning the station to the group ID is based at least in part on the determination.

16. The communication device of claim 15, wherein the data monitor is configured to:
monitor a data transmission queue associated with each of the stations assigned to the group ID to determine whether that station has data ready for transmission.

17. The communication device of claim 13, wherein the station assignment administrator is configured to:
determine another group ID is assigned to the station, wherein a group of stations associated with the other group ID has insufficient data for a multi-user transmission; and
disassociate the station from the group ID.

18. The communication device of claim 13, wherein the station assignment administrator is configured to assign the station to the group ID based at least in part on a modulation and coding scheme (MCS) of the station such that a group of stations from the plurality of stations associated with the group ID have the same MCS.

19. The communication device of claim 13, wherein the station assignment administrator is configured to assign the station to the group ID based at least in part on a traffic priority of the station.

20. A non-transitory computer-readable medium storing code for communication at a wireless device, the code comprising instructions executable to:
identify a plurality of stations, wherein each station of the plurality of stations supports multi-user transmissions;
determine a group identifier (ID) threshold for a station in the plurality of stations, the group ID threshold indicating a maximum number of group IDs permitted to be assigned to the station; and
assign the station to a group ID based at least in part on the group ID threshold associated with the station.
